(19) United States
(12) Patent Application Publication
(10) Pub. No.: US 2006/0074784 A1
(43) Pub. Date: Apr. 6, 2006

(54) Stored value account for use with virtual coupons

(75) Inventor: Jaime P. Brown, Denver, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 10/951,467

(22) Filed: Sep. 27, 2004

(51) Int. Cl. G06Q 40/00

(52) U.S. Cl. 705/35; 705/16

(57) ABSTRACT

A system and method for the purchase of products, wherein a database account is credited with virtual coupons. Each virtual coupon is associated with a maximum value and a specified product. When a purchase is made, the coupon is debited from the account upon presentation of a financial card at a POS terminal, and any difference between the maximum value of the coupon and the actual purchase price is stored in the database. In one embodiment, coupons are issued through a government benefits program, such as the federally funded WIC (Women, Infants, Children) program. The financial card may also be associated with a second account, such as a credit or debit card account. The second account may be used to purchase products other than those specified by the virtual coupons.

### BACKGROUND OF THE INVENTION

Stored value cards have become widely used for many financial transactions, including welfare and “food stamp” programs. For example, under the U.S. food stamps program, many states have set up systems (funded by the federal government) where monthly food stamp values are transferred to a debit account, enabling the recipient to use a debit card to purchase a wide array of food items. Food stamp programs normally permit almost all types of “foods” to be purchased, even those that offer little nutritional value.

More recently, government programs have been initiated that target certain kinds of nutritional foods that are to be purchased at regular intervals in order to promote more healthful eating habits. For example, the WIC (women, infants and children) program, which is also funded largely by the federal government, normally provides paper coupons or checks to recipients, stating specific kinds of foods to be purchased within specified dates. The foods are those that are particularly healthful to mothers and to their newborn and young children. Thus, a WIC check will list the specific food items (formula, milk, vegetables, etc.) and the number of such items to be purchased using a single check. In some instances, the check is signed by the recipient when it is redeemed, and carries a maximum (“do not exceed”) value. A retailer honoring the WIC check is required to enter the amount of the purchase on the check at the time of the purchase, have the recipient sign it, and make sure that only the specific items are purchased (certain brands and certain quantities). The check will also have a data range during which the check must be used (a “first date to use” and a “last date to use” will appear on the check).

Other programs (such as the federally funded “Farmers Market Nutrition Program”) may provide coupons having certain face values, but if purchases are made for eligible items less than the coupon face value, the difference is kept by the merchant. Thus, for example, a recipient may be given a certain number of $5 dollar coupons, which are to be used within a specified period of time for purchasing fresh produce at a “farmer's” market. If any coupon is used for purchase of an eligible item having a cost less than the $5 dollar face amount, the merchant (not the consumer) keeps the difference.

While these highly structured benefits programs, such as the WIC program, have significant societal and individual advantages (e.g., better eating habits and improved health), they can be difficult to administer and do not drive cost conscious behaviors. For example, even if the recipient may be able purchase items for much less than the established maximum value on a WIC check (e.g., by use of “cents off” store coupons or other promotional programs offered by stores or manufacturers), there is little incentive for either the recipient or the merchant to take advantage of those promotional programs. The recipient has no incentive since he/she gets the same items with a single check, regardless of whether other discounts available. A merchant has no incentive to encourage the recipient to take advantage of discounts, since it will lower the price but not increase volume of sales (e.g., a WIC check is good only for a specified quantity of food, and no more than that quantity, even if the price is lower). There is also no convenient way for the merchant to encourage customers to purchase other non-eligible items, for example, by permitting the recipient to use savings from discounts on program eligible items to purchase other non-eligible items.

### BRIEF SUMMARY OF THE INVENTION

There is provided, in accordance with the present invention, a system and method for managing a stored value account used to make purchases, Wherein the account is credited with virtual coupons. The virtual coupons may be associated with a specified maximum value and a specified product, and redeemable for the purchase of the specified product at a price no more than the specified maximum value.

In some embodiments, there is provided a system and method for managing an account, wherein the system includes a database for storing credits to the account, the credits representing virtual coupons having a specified maximum value and a specified product. When the specified product is purchased, the associated coupon is debited from the account and the difference between the maximum value of the debited coupon and the purchase price of the specified product is stored in the database.

In another embodiment, the account credited with virtual coupons is a first account. Transactions may be made to the account through the use of a presentation instrument, such as a financial card, which identifies the first account. A second account may be associated with the first account and also identified by the presentation instrument. Thus a single presentation instrument may be used for purchases against both the first account and the second account.

In one embodiment, the first account is a benefits account credited with virtual coupons issued by a government funded program, such as the WIC (Women, Infants, Children) program. In other embodiments, the second account may either be a financial credit card or debit card account, or alternatively, an account using credits issued under a different government program, such as the federally funded “food stamps” program.

### BRIEF DESCRIPTION OF THE DRAWINGS

FIG. 1 is a general schematic diagram showing a system for facilitating the redemption of coupon units, such as those issued under a government benefits program, in accordance with one embodiment of the invention.

FIGS. 2A and 2B illustrate a benefits program debit card that could be used in conjunction with the system of FIG. 1.

FIG. 3 illustrates a screen display at one of the POS terminals in the system of FIG. 1.

FIG. 4 illustrates a database used in the system of FIG. 1.

FIG. 5 is a flow diagram illustrating the operation of the system of FIG. 1.

A more complete understanding of the present invention may be derived by referring to the detailed description of the invention and to the claims, when considered in connection with the Figures.

### DETAILED DESCRIPTION OF THE INVENTION

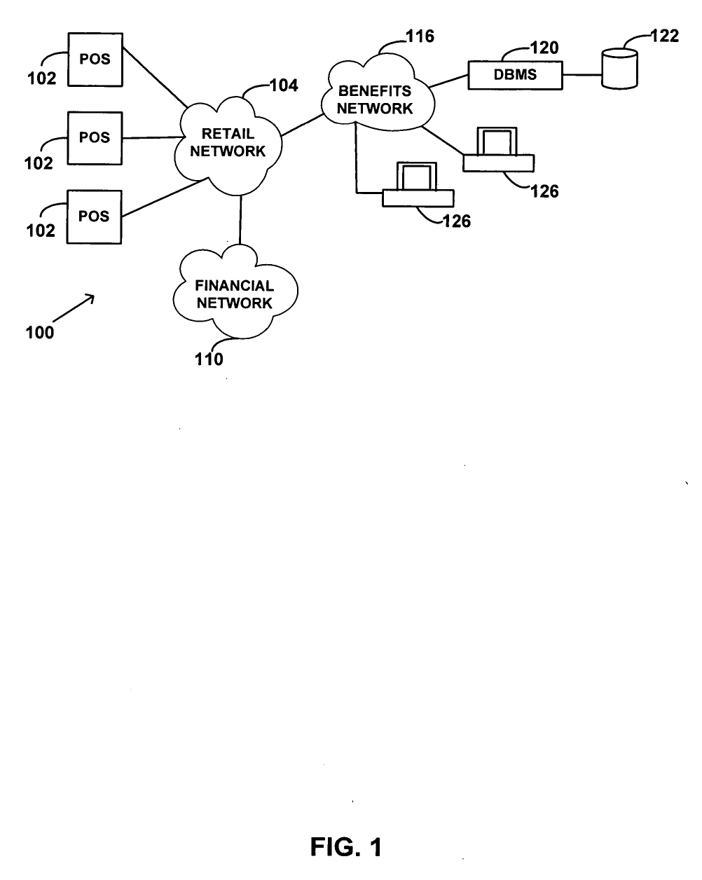

There are various embodiments and configurations for implementing the present invention. One such implementation is shown in FIG. 1, where according to one embodiment of the invention, a system 100 includes a plurality of point-of-sale (POS) terminals 102 connected to a retail network 104. The network 104 is of a well known type, wherein the POS terminals 102 may be located at one (or more) retail establishments (e.g., grocery stores). The POS terminals have price look-up and other functionality, either internally or through interconnection to a server or database (not shown) within the retail network 104. The retail network may also be connected to a banking or financial network 110 in order to handle credit card and other electronic transactions passing through the retail network 104, e.g., originating at POS terminals 102. Further, the retail network 104 may also be connected to a benefits network 116, which may be maintained by a government agency or other program administrator for the purpose of managing a benefits program, such as the previously described WIC program.

Terminals (such as the POS terminals 102) used for conducting retail and similar transactions are well known. Although not illustrated in FIG. 1, such terminals may include a keyboard, a display and various peripheral devices or functions (e.g., magnetic stripe card reader, optical bar code reader, etc.) well know to those skilled in the art. As should also be appreciated, the POS terminals may be operated by a retail clerk when products to be purchased are presented by a customer at a checkout line, or could be self-service terminals used by the customer, without intervention by a retail clerk (e.g., at a checkout station, built into a shopping basket, or located elsewhere within a retail establishment).

When products are taken by a customer to the POS terminal 102, product information or a product ID is entered (e.g., at a keyboard or through use of a bar code scanner). Product information is used to retrieve pricing information (e.g., at a price look-up table within the POS terminal or in a database elsewhere within the retail network 104). The customer may use cash or a financial card (e.g., credit, debit or similar card), and in the case of a card, information may be read at the POS terminal (e.g., at a magnetic stripe reader) and transmitted to a bank or financial institution through financial network 110 in order to authorize the transaction and post it to the appropriate account. The card may be presented at any time during the transaction (before, during or after) product IDs are entered. POS devices and networks for conducting credit card and similar transactions are known and can be found in co-pending, commonly assigned U.S. patent application Ser. No. 10/116,689, entitled “SYSTEMS AND METHODS FOR PERFORMING TRANSACTIONS AT A POINT-OF-SALE,” filed Apr. 3, 2002, by Eamey Stoutenburg, et al., which is a continuation-in-part of U.S. patent application Ser. No. 09/634,901, entitled “POINT OF SALE PAYMENT TERMINAL,” filed Aug. 9, 2000, by Randy J. Templeton et al. The entire disclosures of the referenced patent applications are hereby incorporated by reference.

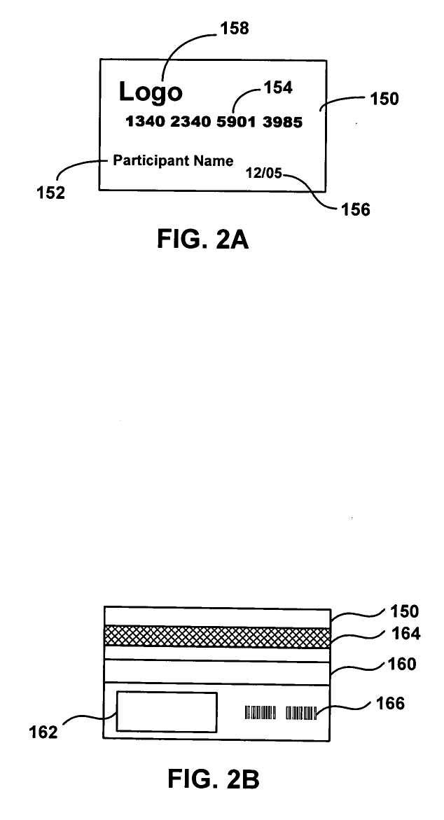

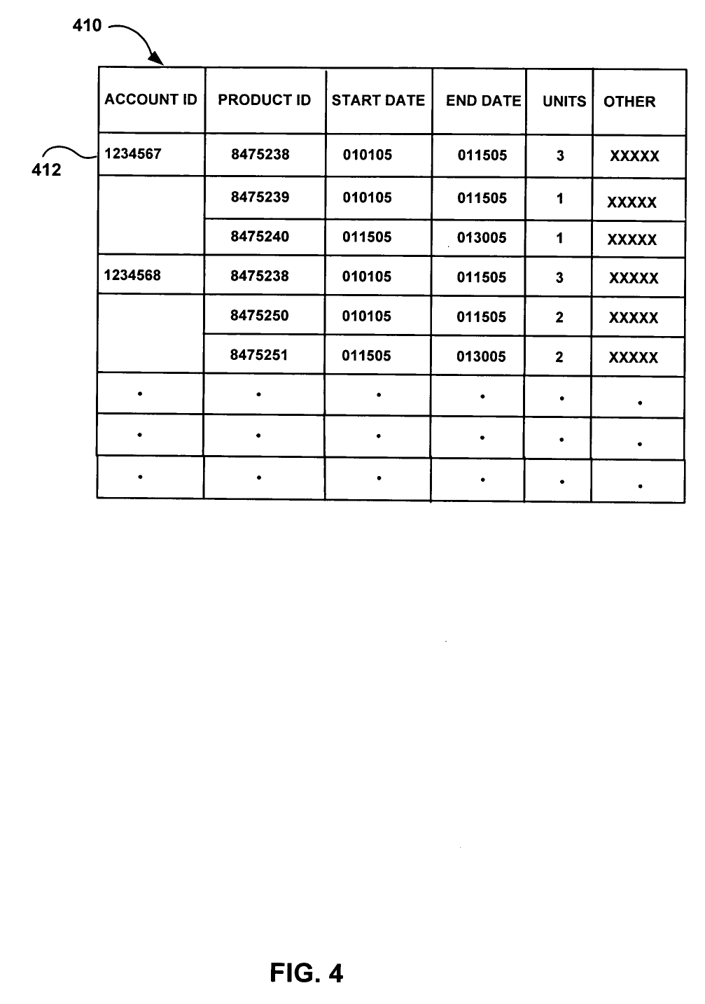

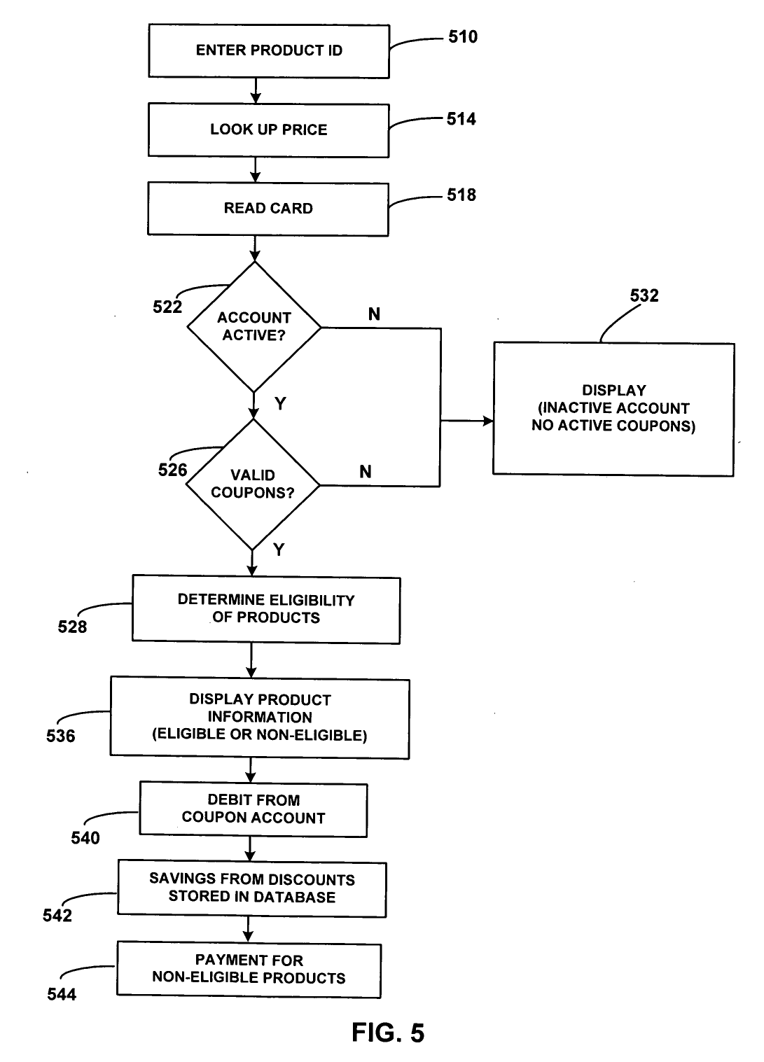

The benefits network 116 is used for processing information entered at the POS terminals 102 that pertains to the redemption of electronic or virtual coupons maintained in a benefits account. In particular, it is anticipated that a customer uses a benefits debit card (to be described later in conjunction with FIGS. 2A and 2B) to identify himself/herself and the account to which eligible purchases may be applied. In one embodiment, the benefits account is one established for the customer under the federally funded WIC program, and is used by the customer to purchase specific items covered under the program, such as baby formula, milk, fresh fruit and other nutritional products, with the items to be consumed and thus required to be purchased within a specified period of time. The data representing the “virtual coupons” maintained in the benefits account, and the operation of the system in redeeming those coupons, will be described in greater detail later in conjunction with FIGS. 4 and 5. However, briefly, as an example, one coupon in the account may be intended to cover baby formula needed to properly feed an infant during a two week period. The customer takes her benefits card to a participating grocery, and redeems that virtual coupon in the account to purchase the specified quantity of baby formula that will last for the two week period, with the redemption permitted by the system only during the redemption period specified by the coupon.

In the system of FIG. 1, customer and account information is entered (e.g., by reading a magnetic stripe on the benefits card at one of the POS terminals 102), and is communicated through the retail network 104 to the benefits network 116. The benefits network 116 links systems, terminals and databases operated by the program administrator, including a database management system or server (DBMS) 120 which manages an associated data store or database 122, and terminals 126. The database 122 stores data (to be described in greater detail later in conjunction with FIG. 4) which may, among other things, identify program participants, account balances, and product IDs for program eligible products. The DBMS 120 and database 122 may include any one of numerous forms of storage devices and storage media, such as solid state memory (RAM, ROM, PROM, and the like), magnetic memory, such as disc drives, tape storage, and the like, and/or optical memory, such as DVD. The database 122 may be co-located with the DBMS 120, it may be integral with the DBMS 120, or it may represent (with DBMS 120) distributed data systems located remotely in various different systems and locations. The terminals 126 are workstations used, for example, by administrative staff when accessing the DBMS 120 and other systems connected to the network 116.

The networks 104, 110 and 116 may be implemented using the Internet, an intranet, a wide area network (WAN), a local area network (LAN), a virtual private network, or any combination of the foregoing. The networks may include both wired and wireless connections, including optical links. For example, the POS terminals may be portable wireless terminals (stationary or mobile) linked to the retail network 104 by wireless communications channels.

While each of the networks 104, 110 and 116 is illustrated in FIG. 1 as a separate network, all could in fact be a single, integrated network (maintained by a financial institution that both processes financial transactions from merchant locations and administers one or more government funded programs). Alternatively, the networks 104, 110 and 116, could each be multiple networks. For example, the financial network 110 could represent multiple bank networks connected to the retail network 104 so card transactions for accounts maintained at any one of several different banking or financial institutions may be processed. Also, the benefits network 116 could represent multiple benefits networks, each administering different programs for different participants and each connected to the retail network 104 for processing benefit transactions when one of its participants presents an benefits card at one of the POS terminals 102.

Also, while the POS terminals 102, DBMS 120 and database 122 are illustrated as separate devices or systems geographically distributed across various networks, they (and their functionality) could all be co-located at a single location and could even all be integrated into a single computing system or device.

FIGS. 2A and 2B show the front and back sides, respectively, of a presentation instrument or benefits card 150 that could be used by a customer (e.g., as a stored value or debit card) when making purchases (redeeming virtual coupons) at one of the POS terminals 102, according to one embodiment of the invention. For purposes of the present description, it is assumed that the customer presents the card 150 after purchases have been brought to the POS terminal and each product ID number has been entered (e.g., by use of a keyboard or optical bar code reader). However, as mentioned earlier, the card may be presented at any time (e.g., before, during or after product ID's have been entered).

The card 150 is used to identify the participant (as someone eligible for benefits under a government funded program), and provide information to the POS terminal 102 in order to verify eligibility and/or settle transactions. One side of the card may be embossed with the participant/customer name 152, an account number 154, and an expiration date 156. The card may have the name or logo 158 of the payer (program administrator).

The back side of the card may include a signature line 160, and printed program information 162. Program information may include instructions for use of the card, a program administrator phone number, and other similar information.

The card also includes one or more information encoding features. Information encoding features may include a magnetic stripe 164, a bar code 166, a smart chip (not shown), and the like. It is to be understood that many other examples of a presentation instrument and associated information encoding features are possible.

In the illustrated embodiment, the card number 154 identifies the administrator/institution/agency maintaining the benefits account as well as the customer's individual account. Similar to conventional credit or debit card transactions, such information is used by the POS terminal and retail network 104 to route the transaction data to the benefits network 116, where the account of the participant (customer) is accessed (to be more fully described later).

The card 150 permits the participant to identify and purchase products that are eligible for redemption using the virtual coupon units stored in her account. Thus, after the product ID for each product to be purchased is entered at POS terminal 102, and after participant information (benefits account number, etc.) is read from the card at the POS terminal 102, such information is transmitted through retail network 104 and benefits network 116 to DBMS 120. The DBMS 120 accesses database tables in database 122 that have the participant's account information and also information concerning eligible products and purchases. The customer is then informed at the POS terminal 102 whether specific products are eligible for purchase using the account. The customer is then asked whether such eligible purchases are to be paid for using the benefits account (i.e., debiting purchases against the virtual coupons maintained in the account).

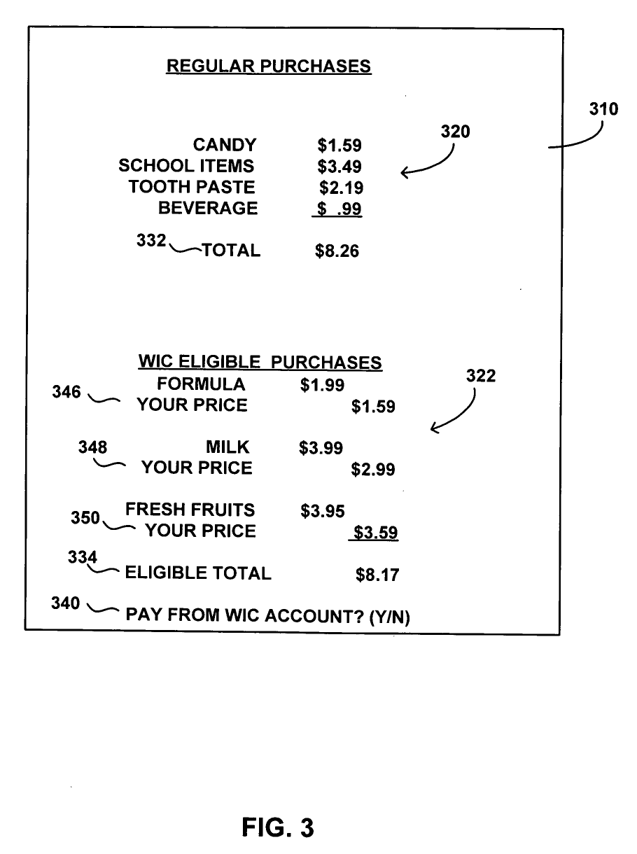

FIG. 3 illustrates a screen 310 that could be displayed at one of the POS terminals 102. The screen 310 facilitates the purchase of program eligible products by displaying eligible products separately from non-eligible products, and permitting the customer to have purchases made (debited) against the benefits account. As seen in FIG. 3, various products have been presented (and their product IDs read) at the POS terminal 102. Those products and their prices are displayed. Further, the customer has presented a benefits card (such as the card 150 seen in FIG. 2), and program eligible products have been determined (the various steps for such determination will be described later). Thus in FIG. 3, the screen 310 displays the purchased products as either regular (non-eligible) purchases 320 or as eligible purchases 322 (in this case, products eligible under the WIC program). A regular purchase total 332 as well as a separate program eligible total 334 are displayed, and the customer (whose has been identified by accessing database 122 as a participant in the program having coupons or credits in the account) is asked through use of the display (at display line 340) whether eligible products are to be debited against the benefits (WIC) account. Upon selection for purchase using the benefits account (such as by use of a keyboard or a touch screen entry), the account is debited (the applicable coupons are redeemed) and the customer is then responsible for payment (cash, check, credit card, etc.) for other, non-eligible items. The payments from the benefits account to the retail establishment or merchant are handled in the same manner as a conventional debit card transaction, with the amount debited from the benefits account being electronically transferred through a clearing house network (e.g., financial network 110) and credited to the account of the merchant.

In addition to displaying the normal purchase amount for each eligible product, the screen 310 seen in FIG. 3 may also display a special, discounted price (see display lines 346, 348 and 350). The discounted price may, for example, reflect a price reduction because the customer had presented a “cents off” coupon, or because the customer has taken advantage of a special promotional program offered by the merchant (e.g., the price is “half off” if other unrelated items are purchased at the same time).

It should be appreciated that information other than that seen in FIG. 3 could also be displayed on screen 310 (e.g., name of the participant, his/her account number, the remaining balance of coupons in the account, etc).

The screen in FIG. 3 can thus be seen as a convenient way to facilitate the purchase of eligible products and to capture any special discounts to the regular price of eligible products. The totals of any discounts (difference between the coupon value and discounted price) may be stored in database 122 for various purposes, such as refund to the program administrator, or perhaps credited (in whole or in part) to the account of the participant. Capturing such discounts at the time of purchase assures that the savings from any discount can be captured for later use, rather than being “pocketed” by the merchant.

Such data can also be used for many purposes useful to the program administrator and its participants, such as determining the coupon use habits of participants, encouraging participants to take advantage of discounts by permitting the discount (or a portion thereof) to be credited to the participant to use for other (eligible or non-eligible) product purchases, etc.

Of course, other data related to the transaction can also be stored in relation to redeemed coupons (date of purchase, other food products being purchased at the same time, the extent of discounts that participants are obtaining, etc.).

FIG. 4 illustrates in simplified form the content of a database table 410 within the database 122 (connected to the benefits network 116) and used in conjunction with POS terminal 102 (and screen 310 in FIG. 3) for facilitating the purchase of program eligible products. The database 410 is relational, i.e., relating to each participant account (identified by account number or ID) the specific products which may be purchased, and the dates (“start date” and “end date”) during which the purchase of the specified product is eligible under the program, and the number of products (units) that may be purchased. As an example, and referring to the first line 412 of the database table 410, for one illustrated participant (account ID “1234567”), several products are eligible, including product ID “8475238” which may be purchased during the period beginning on Jan. 1, 2005 (“010105”) and ending on Jan. 15, 2005 (“011505”), in a unit quantity of three. The product ID, start and end dates, and unit information thus represent a virtual coupon in the account.

While not specifically shown, other information may also be provided in connection with each account, such as a PIN (in the event required for accessing the account), participant name, address, related accounts (the use of which will be described later), and any other personal information of the participant useful in managing the account.

As should be apparent, the database table 410 may be updated as needed, e.g., when a participant is periodically re-certified as eligible to receive benefits, and at that time the database can be loaded with the IDs of the various products that can be purchased and the dates during which each product may be purchased.

The functionality implementing the embodiments described in FIGS. 1 through 4 is largely data and applications resident at the POS terminals 102, and at the DBMS 120, depending on the configuration of the various devices with the system 100. A flow diagram illustrating the program steps implementing some embodiments of the invention is shown in FIG. 5.

Turning to FIG. 5, when the customer brings products to be purchased to the POS terminal 102, the product ID (e.g., from a bar code) is entered at the POS terminal, step 510, and the terminal accesses, step 514, a price-look up table (either at the POS terminal or within a data system elsewhere within retail network 104) in order to retrieve a price and, if desired, other information such as a product name, etc. The retrieved information is received at the POS terminal, and it may or may not at this point be displayed at the POS terminal, but if it is displayed, it will not yet reflect whether the product is eligible under the benefits program (since benefits information has not been entered). At step 518, program benefits information is entered at the POS terminal, such as by reading the magnetic stripe 164 on the card 150. The transaction data (e.g., product ID) and the program account information (e.g., account number on the card 150) is sent through benefits network 116 to the DBMS 120, so that the database 122 may confirm that the account is present and active (step 522) by comparing the account number against account numbers or IDs in table 410, and may determine whether there are currently valid coupons in the account (e.g., the transaction date matches the redemption dates for any coupons), step 526. If the account is not active or there are no currently valid coupons, information to that effect is displayed at the terminal 102, step 532. Next, DBMS 120 determines at step 528 which if any of the products being purchased are eligible under the program by comparing products purchased against the product numbers or IDs in table 410.

If the account is active and has at least one valid coupon, then the information in screen 310 seen in FIG. 3 is displayed at POS terminal 102, step 536, in order for the customer to see which products are eligible. The customer elects whether to have the eligible products purchased through redemption of coupons in the account, at step 540 (it should be appreciated that a customer could decide to pay out of his own pocket for an eligible product rather than redeem a coupon, even if there is a valid coupon in the account), and any savings or discounts from the coupon value price are stored at step 542. The customer then handles the payment for non-eligible products (or eligible products not being purchased with the benefits account) at step 544, either by paying with cash or check, or using a separate credit or debit card.

It should be appreciated that the flow diagram in FIG. 5 is only one example of a process that could be carried out by application programs within the system 100. Additional steps may be performed, and the order of illustrated steps may be changed. For example, additional screens could be displayed to lead the customer/clerk through the transaction. Also, the benefits card could be presented, and benefits information read (and displayed at screen 310) before any product information is entered at the POS terminal.

It should be appreciated from the preceding discussion that the present invention provides a novel method and system for facilitating purchase of products or items, where items may be purchased by redemption of virtual or electronic coupons maintained in an account. While detailed descriptions of presently preferred embodiments of the invention have been given above, various alternatives, modifications, and equivalents will be apparent to those skilled in the art without varying from the spirit of the invention. For example, while the benefits card 150 is described for use in purchasing program eligible products, it may also be used to facilitate the purchase of non-eligible products. For example, a separate credit card/debit card account could be associated with the benefits account (e.g., the associated account number is related to and stored with the benefits account number in table 410 of database 122), so that non-eligible products may be purchased using an associated credit/debit card account at the same time that eligible items are purchased using the benefits account. In such case, when the benefits account is accessed, the related non-benefits account number may be retrieved and sent to the POS terminal, and used by the POS terminal to access the separate account over the financial network 110. If desired, the savings from discounts used with redeemed coupons could be stored in the related account.

Also, a participant may be eligible for several programs, e.g., a WIC program for purchase of only a limited number of WIC eligible food products, and a food stamps program for purchase of a much wider variety of food products. The same card could be used to redeem WIC coupons maintained in a WIC benefits account and to purchase other food products using “food stamps” maintained in a separate food stamp account.

Thus the customer may avoid having to carry two cards, one for WIC purchases and a separate card for other purchases.

Further, the participant need not carry a card. Rather the presentation instrument could be an RFID (radio frequency identification device), which is carried by the participant (e.g., as a key fob) and which electronically transmits benefits information when passed near a transceiver at the POS terminal, so that the entire transaction can be conducted without presenting or reading/swiping a card. As a further example, the presentation instrument need not be a tangible instrument at all, but could be simply an identifier or password issued by the program administrator (e.g., string of characters) that a customer has memorized and that could be entered (along with an optional security code/PIN) at the POS terminal whenever a transaction is to be conducted.

Therefore, the described embodiments should not be taken as limiting the scope of the invention, which is defined by the appended claims.

What is claimed is:

1. A method for managing an account used for purchasing products, comprising:
providing a database;
storing credits to the account in the database, the credits representing virtual coupons, each coupon associated with a specified maximum value and a specified product, and redeemable only for the purchase of the specified product at a price no more than the specified maximum value;
purchasing the specified product based on a purchase price, and debiting the associated coupon from the account in the database; and
storing in the database a value reflecting the difference between the maximum value of the debited coupon and the purchase price of the specified product.

2. The method of claim 1, wherein the specified product is a plurality of individual product items.

3. The method of claim 1, wherein each coupon is further associated with a date range, and wherein the coupon is redeemable only if the purchase is within the date range.

4. The method of claim 1, wherein purchases are made against the account through use of a presentation instrument.

5. The method of claim 4, wherein the account is a debit account and wherein the presentation instrument is a debit card.

6. The method of claim 5, wherein the debit account may be used only for purchasing products by redeeming coupons.

7. The method of claim 4, wherein the virtual coupons are issued through a government funded program for providing food items to program participants.

8. The method of claim 7, wherein the government funded program is the WIC (Women, Infants, Children ) program.

9. The method of claim 8, further comprising:
establishing a second account associated with the presentation instrument, the second account for purchases other than the purchase of a specified product made by redeeming coupons, and wherein the stored value reflects the difference between the maximum value of a debited coupon and the purchase price of the specified product is credited to the second account.

10. A system for conducting a sales transaction for products using benefits coupons, each coupon associated with a specified maximum value and a specified product, and redeemable only for the purchase of the specified product at a price no more than the specified maximum value, and each coupon further having a date range defined by a first date to use and a last date to use, the system comprising:
a POS terminal at a merchant location for obtaining a product ID for a specified product at the time the product is presented for purchase, and for obtaining an account ID for an account to be used in making the purchase; and
a data base for maintaining the account, the database storing data associated with virtual coupons posted to the account, each virtual coupon corresponding to a benefits coupon, whereby the stored data associated with each virtual coupon reflects the maximum value, specified product, and date range of the corresponding benefits coupon; and
a database management system for managing the database and receiving data from the terminals, so that when a product ID and coupon account ID are received, the database system debits a virtual coupon from the account upon purchase of a specified product, if the product ID corresponds to the specified product, the purchase price is no more that the maximum value, and the time of purchase is within the data range.

11. The system of claim 10, wherein the database system stores the difference between the purchase price of the specified product and the maximum value of the benefits coupon.

12. A method for conducting transactions using a presentation instrument, comprising:
establishing a first account;
providing credits to the first account in the form of virtual coupons, each coupon associated with a specified maximum value and a specified product, and redeemable only for the purchase of the specified product at a price no more than the specified maximum value;
conducting a sales transaction at a POS terminal for the specified product upon presentation of the presentation instrument, the presentation instrument identifying the first account;
establishing a second account, the second account also identified by the presentation instrument so that transactions may be conducted against the first and second account with the use of a single presentation instrument.

13. The method of claim 12, wherein the first account is established to provide benefits under a government funded program.

14. The method of claim 13, wherein the first account is a stored value account providing benefits under the WIC (Women, Infants, Children ) program.

15. The method of claim 14 wherein the second account provides benefits under a food stamps program.

16. The method of claim 14, wherein the second account is a separate credit/debit card account.

17. The method of claim 12, wherein the presentation instrument is a financial card.

18. The method of claim 12, wherein the presentation instrument is an RFID device.
